(19) United States
(12) Patent Application Publication
(10) Pub. No.: US 2003/0230721 A1
(43) Pub. Date: Dec. 18, 2003

(54) Sensitivity control for PIR motion detector

(76) Inventor: Wade Lee, Danville, CA (US)

Correspondence Address: ELLIOT B. ARONSON, 5001 HARBORD DRIVE, OAKLAND, CA, 94618

(21) Appl. No.: 10/369,804

(22) Filed: Feb. 20, 2003

Related U.S. Application Data
(60) Provisional application No. 60/388,978, filed on Jun. 14, 2002.

(51) Int. Cl. G01J 5/02

(52) U.S. Cl. 250/342; 250/DIG. 1

(57) ABSTRACT

A gain control technique for controlling the sensitivity of a passive infra-red motion detector. A manually adjustable gain control element such as a potentiometer is coupled to the PIR amplifier circuit at the final amplification stage so as to apply a greater potential difference across the gain control element to retard the deleterious effects of corrosion or other conduction-reducing influences and so that noise induced in the leads from the gain control to the circuit will not undergo any significant amplification compared with the desired signal from the PIR sensor.

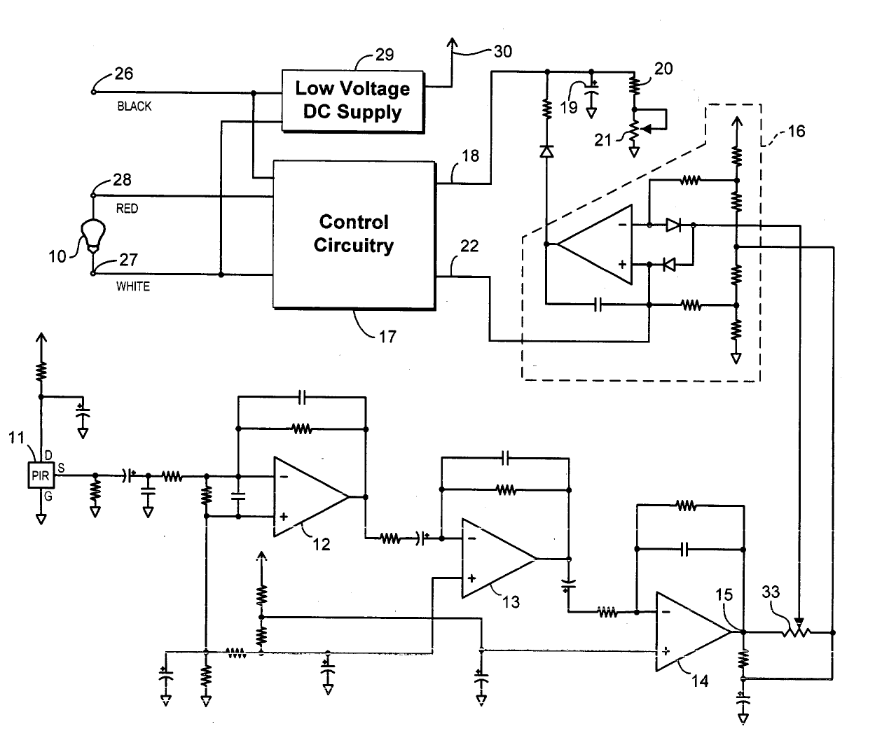

This application claims the benefit of provisional application No. 60/388,978 filed Jun. 14, 2002.

### BACKGROUND OF THE INVENTION

The present invention relates to passive infrared (PIR) motion detectors of the type used in outdoor lighting fixtures to illuminate an area such as a walkway or driveway when a person or automobile approaches. The invention is more particularly directed to a gain control technique for controlling the sensitivity of the circuitry.

Outdoor motion-activated lighting fixtures are found in widespread use to monitor and illuminate areas around houses, other buildings, walkways, driveways, garden areas, gateways or other areas subject to pedestrian traffic. A gain control included in the electronic circuitry is one of the ways a motion-activated fixture can be adjusted for different monitored areas. For example, the same model of lighting fixture may be installed by different purchasers in different settings to monitor a great variety of areas having different sizes and shapes and covering different terrains. Some fixtures are mounted by a doorway to monitor a short walkway, others a long walkway. Some are mounted to monitor broad areas, others narrow areas. Some are mounted high, some are lower. Some are mounted on building walls, others on posts, columns or other landscaping structures removed from buildings. Some are mounted close by a sidewalk, street or other public area that is likely to have pedestrian or vehicular traffic that is not desired to trigger the light to come on. Some are mounted more removed from such unwanted targets. Some are mounted on an upslope, some on a downslope.

An adjustable gain control for electronically adjusting the motion detector's sensitivity and thus the range covered by the motion detector is one means by which a user may adapt the motion detector to the particular area to be monitored. For example, in a fixture mounted closer to the street the gain may be reduced so that the monitored area does not extend into the street, that is, so that unit will not be sensitive enough to respond to passing vehicles or pedestrians. When the same model fixture is mounted by a doorway set back a greater distance from the street, the gain may be increased to cover the greater distance to the street. The gain control has become a common feature for adapting motion detector s to different environments.

### SUMMARY OF THE INVENTION

The present invention provides a sensitivity control for PIR motion-activated lighting circuitry that increases the mean life of the circuitry while at the same time reducing a heretofore unappreciated source of false activations—that is, spurious activations of the light in the absence of a desired moving target. It is an object of the invention to provide for a longer lifetime of operation by preventing or retarding the deleterious effects of corrosion or other fouling of a critical circuit component that could lead to circuit failure. It is another object of the invention to reduce false activations or misactivations due to noise interference commonly induced in gain controls of the prior art. These objects are achieved through judicious placements of an electronic sensitivity control in the circuit.

In some forms of PIR motion detector circuitry a comparator arrangement is used to compare a signal representing the sensed infra-red radiation with a specified threshold level to determine whether the sensed infra-red radiation is sufficiently great to turn on the light. The sensitivity control placement disclosed here is particularly beneficial with such thresholding systems to reduce false and misactivations.

It is another aspect of the invention to provide these features in a circuit that is cost effective to fabricate and does not require an excessive number of additional components.

Other aspects, advantages, and novel features of the invention are described below or will be readily apparent to those skilled in the art from the following specifications and drawings of illustrative embodiments.

### BRIEF DESCRIPTION OF THE DRAWINGS

The FIGURE shows an electronic schematic diagram of a passive infra-red motion detector circuit incorporating an embodiment of the invention.

### DETAILED DESCRIPTION OF ILLUSTRATIVE EMBODIMENTS

A large variety of passive infra-red motion detector circuits are known and can be devised for energizing a light in response to motion. The invention is illustrated in the FIGURE in one such circuit embodiment, which is offered here only for purposes of illustration and no limitation to this specific circuit embodiment is intended. A general overview of the circuit shown in the FIGURE will be given first, and then the innovations of the invention will be described in more detail.

The circuit functions to energize a light 10 in response to movement in the region monitored by the motion detector. The motion detector includes an infra-red (PIR) sensor 11, which responds to changes in infra-red radiation incident upon the sensor from the monitored region and provides a sensor output voltage signal representing the changes in incident infra-red radiation. The incident radiation may originate from a person or other target of interest moving in the monitored region or it may stem from other, extraneous sources. The sensor output signal is applied to an amplification and filtering section, which in the embodiment illustrated here includes a first amplification stage, an intermediate or penultimate amplification stage, and a last amplification stage provided respectively by op amps 12, 13 and 14 and associated components. For brevity these stages are referred to simply as amplification stages although they may generally perform a filtering function as well. Although the invention is illustrated here in a circuit with three stages of amplification, three stages are not necessary and the advantages of the invention may be achieved with conventional amplifying sections having only two amplification stages or in some circuits possibly only one such stage.

The amplified signal from the output of the final amplification stage at output node 15 is applied to a thresholding element, provided here by a window comparator 16, which detects whether the signal indicates the presence or absence of motion, that is to say, discriminates whether the infra-red radiation incident upon sensor 11 most likely emanated from a desired target moving within the field of view and range monitored by the motion detector. A desired target such as a person within the range of the motion detector will typically cause a noticeably larger change in incident infrared radiation than other sources. The window comparator determines whether the signal is of sufficient magnitude to warrant energizing the light. When the signal from the amplification section exceeds a threshold magnitude, the signal is assumed to stem from a desired target in the region monitored by the device. When such a sufficiently large signal is detected, indica ting a desired target is present in the monitored region, the thresholding element provides a triggering signal at its output, which is applied to control circuitry 17 along line 18. The control circuitry causes light 10 to be energized in response to the trigger signal. Signals at window comparator 16 less than the threshold value are assumed to stem from something other than a desired target and no triggering signal is provided. One the light is energized in response to the triggering signal, the light remains energized thereafter for a duration (typically five to fifteen minutes) governed by the time constant of the RC circuit comprising capacitor 19 and resistors 20 and 21. The use of window comparators and other thresholding comparator arrangements in PIR motion detectors for this purpose is common, and their structure and operation are well known to those of ordinary skill in the art and need not be described in any further detail here. The control circuitry may perform other functions as well, such as providing a signal along line 29 to window comparator 16 for disabling the motion detector during daylight hours. Such control circuitry is well known in the art and plays no role in the invention. It is mentioned here only by way of general background.

Power for energizing light 10 and for operating the motion detector circuitry is provided by the line voltage of the AC power mains (typically at 120 Volts or more) through leads 26 and 27. Light 10 is connected across lead 27 and a switched lead 28. In response to the trigger signal, control circuitry 17 connects switched lead 28 to main lead 26 thereby energizing the light. Low-voltage power supply, circuitry 29 receives AC power from the line voltage of the utility mains at leads 26 and 27 and provides a low-voltage DC supply at 30 for powering the motion detector circuitry. In common motion detector circuits the low-voltage DC supply is typically a voltage between 5 and 12 volts.

In the embodiment of the FIGURE a single sensor 11 is shown for illustration. The circuitry may also be used with a plurality of sensors, which for example may be ANDed together, and no limitation to a single sensor is intended.

The motion detector apparatus generally contains an optics arrangement employing lenses and/or mirrors or other apparatus for directing infrared radiation to the sensor or plurality of sensors. Such arrangements are well known and are not the subject of the present invention and thus need not be disclosed herein. Those skilled in the art will appreciate from the disclosures herein that the circuit innovations of the present invention may be used to advantage with a wide variety of such sensor and optics arrangements.

Attention is now directed to the sensitivity control provided in the FIGURE bar potentiometer 33 coupled between the output node 15 of the final stage op amp 14 and window comparator 16. Potentiometer 33 provides a manually adjustable resistive load at the output of the last amplification stage. This is not the customary location for a sensitivity control in PIR motion detector circuitry. Such control, if provided at all, is normally positioned at the input to the first amplification stage or sometimes at the output of the first amplification stage. Here however the sensitivity control is disposed at the final amplification stage to overcome two specific problems found in outdoor motion detectors or in motion detectors that may be used in harsh environments such as certain industrial environments. One problem relates to the useful life of the gain control potentiometer. The other relates to noise picked up by the gain control leads.

Failure analysis of motion detector circuits that have been used in the field for long periods of time shows that many failures are due to breakdown in the potentiometer that controls the sensitivity, that is, that controls the amplifier gain. This is found to be generally due to oxidation or corrosion or dirt building up at the potentiometer, which interferes with the proper operation of the potentiometer until the circuit eventually fails. This problem is greatly overcome in the circuit shown in the FIGURE by putting the potentiometer after the final amplification stage because in this position an appreciably greater potential difference is applied across the potentiometer that can impede the onset of corrosion or other conductivity-impairing degradation or break through such corrosion or other degradation as it first starts to occur.

Popular pyroelectric infra-red sensor chips of the type typically used in outdoor motion detectors provide an output signal that may vary over a range up to at most a few millivolts as a person moves about in the region being monitored by the motion detector. The maximum output occurs when an infra-red source moves very close to the sensor. Most of the time, however, the output is at a lower voltage level in response to persons moving about in the greater region monitored by the motion detector or in response to undesired background infra-red disturbances. When the potentiometer is positioned before the first amplification stage, it is subjected to voltage signals on the order of the output voltage of the sensor chip, that is, on the order of at most a few millivolts, and usually less, as a person moves about in the monitored field of the motion detector. Even if the potentiometer is positioned after the first amplification stage, the voltage levels across the potentiometer will still be quite low. For example, the individual amplification stages of PIR motion detector circuits of the prior art commonly have a single-stage voltage gain of up to about 100 and frequently less. Thus, for a maximum sensor chip output signal of, say, 5 millivolts (mV), and most of the time the output is lower-a potentiometer positioned after the first amplification stage will experience a potential difference of at most about 0.5 Volts, and most of the time only some fraction of that. By contrast, when the potentiometer is positioned after the final stage, it may experience a greatest potential difference roughly equal to the low-voltage DC supply level typically five to twelve volts depending on the circuit. This is so either because the initial signal is amplified to that level or because the last amplifier stage saturates at or near the low-voltage DC supply. The greater potential difference across the potentiometer in this configuration leads to longer life, hence greater reliability, of the sensitivity control and hence longer useful life for the motion detector as a whole. The specific voltage gain, signal level and noise level used here are offered only by way of example to elucidate the operation of the invention in a specific case. The actual signal levels and noise levels in any given case depend on such factors as the particular circuit embodiment, the particular components used, the environment of use, and possibly even the age of the components. Moreover, any given circuit embodiment may use a different gain ratio or may even use a different gain for each amplification stage.

While it may be known in other sorts of electrical devices to place a gain control after the amplification stages, such a configuration is used here to overcome a problem that has not been fully appreciated before—that of premature failure of the motion detector due to corrosion or other degradation in the gain control mechanism. Not only has the problem not been fully appreciated, but all the more so it has not been appreciated that shifting the position of the gain control in the circuit would lead to a solution to the problem.

In some circuits embodying the invention something less than the full low-voltage supply may be applied across the manually adjustable portion of the gain control. In some circuits arrangements the low-voltage supply level may be reduced by insignificant diode junction levels before being applied to the potentiometer; in others by additional resistive elements introduced to limit the maximum or minimum of the adjustable sensitivity range. For example, in some embodiments it may be desirable to permit only mid-level to high-level sensitivity adjustments while maintaining a minimum low-level sensitivity so that the user cannot inadvertently completely disable the motion detector with the sensitivity setting. In any case at least a substantial fraction of the low-voltage supply should be available to be applied across the potentiometer or other manually adjustable portion of the gain control so that the potential drop across the manually adjustable portion is nevertheless on the order of volts, and in any case greater than about 1.5 Volts, as the final amplifier stage undergoes its maximum voltage swings. In this way every time a person moves into or within the monitored region, the potentiometer is given one or more applications of a cleansing voltage signal.

Placing potentiometer 33 at the final amplification stage serendipitously solves a second problem commonly experienced by PIR motion detectors. The circuitry for the PIR motion detector is typically mounted on a printed circuit board that is included within the lighting fixture, either in the body of the motion detector housing or sometimes in a mounting base. The manually adjustable sensitivity control necessarily includes a knob, screw or other such element for the user to turn, either by hand or with a screwdriver, to make the adjustment. The adjustment knob is positioned at a convenient place on the fixture housing or mounting base so that it will generally be out of sight, yet will still be accessible to the user for adjustment. Wire leads then run from the potentiometer at its manually engageable location to the appropriate place on the printed circuit board, generally at or close to an amplifier op amp. In some cases these leads may be several inches long. For motion detectors mounted on a building wall these wire leads act as a small antenna picking up low-frequency noise interference typically generated within the building from such sources as motors used with refrigerators, pumps, fans, washing machines, air conditioning and the like or other electrical noise carried for example on the AC power leads. When the gain control is electrically coupled into the circuit at the front end of the amplifier section as in the prior art, the components of such noise falling within the pass band of the amplifier are amplified along with any desired signal and, even in the absence of any desired signal, can produce false activations and also can produce misactivations. That is to say, the amplified spurious noise signals can combine with other desired or undesired signals and shift the signal level so that undesired non-motion signals may be interpreted as motion and desired motion signals may be disguised as non-motion. Coupling the gain control into the circuit at the final stage as taught here is a simple way to overcome such noise interference and yields a much higher signal-to-noise ratio with respect to such noise sources and thus greatly diminishes, if not entirely eliminates, false activations or misactivations due to such noise sources.

While the operation of the invention is illustrated here in a circuit that uses a thresholding technique implemented with a window comparator to discriminate a desired target moving in the field of view, other discrimination techniques, such as other comparator techniques or even pulse-counting techniques, are also commonly used. Many of the benefits of the invention may be enjoyed regardless of the motion-discriminating technique employed. Accordingly, the invention is not intended to be limited only to circuit arrangements using thresholding or window comparators.

The gain control of the invention is illustrated in the FIGURE as disposed after the last amplification stage. In PIR motion detectors that employ a thresholding technique for discriminating motion, the gain control will generally be disposed directly after the last amplification stage and before the thresholding circuitry. A gain control according to the invention may also be used with motion detectors that employ a pulse counting technique for discriminating motion. Such configurations often include pulse-shaping circuitry, which may be disposed subsequent to the amplification section. In such configurations a gain control according to the invention need not be disposed directly in or following the final stage of amplification, but may also be incorporated into or disposed after the pulse shaping circuitry. The important point to impede long-term failure of the circuit, and thereby achieve a longer lifetime, is that the gain control circuitry be disposed so that at least a substantial fraction of the low-supply voltage level be applied across the gain control. The important point to achieve the reduction in noise interference from signals picked up by the gain control leads is that the gain control be electrically disposed in the circuit so that most if not all of the sensor signal amplification takes place before the gain control. Thus, in the FIGURE gain control potentiometer 33 comes after the last amplification stage and thus controls the gain by attenuating the signal after the signal has been fully amplified. That is, the potentiometer serves as a simple voltage divider determining the fraction of the amplified signal to be applied to the window comparator. While implemented here as a simple voltage-dividing attenuator applied after the final amplification stage, the gain control may also be coupled to adjust the gain of the final stage, for example, through the feedback network or by any other means. In the embodiment illustrated in the FIGURE, which has three stages of amplification, some benefit may even be derived by placing the gain control potentiometer before the last amplification stage, that is, between the last amplification stage and the penultimate one. For example, if the individual amplification stages each have a conservative voltage gain ratio of, say, 20, a 0.2-mV noise signal picked up by the potentiometer leads will only amount to 0.004 V if it passes only through the last amplification stage, and this will introduce little in the way of inaccuracies.

In summary, the adjustable gain control may be disposed in a number of positions to achieve the benefits of the invention. To achieve the reduced spurious activations and misactivations from noise interference induced in the gain control leads, the adjustable gain control element may be positioned so as to adjust the gain parameter of the final amplification and filtering stage, as in a feedback loop, or it may be positioned immediately following the final amplification and filtering stage so as to attenuate the signal passed to the subsequent motion-discriminating circuitry, or it may be positioned later in the signal path, say after intervening pulse-shaping or other signal-conditioning circuits. By way of terminology, all such dispositions are referred to herein as dispositions “at” the final amplification stage. In addition, for a three-stage amplifier the gain control may also be positioned to advantage before the last amplification stage and after the intermediate one. To achieve the longer life from reduced buildup of corrosion, the adjustable gain control element need only be positioned where it will be subjected to at least a substantial fraction of the low-voltage supply level, on the order of volts. The above descriptions and drawing are given to illustrate and provide examples of various aspects of the invention in various embodiments. It is not intended to limit the invention only to these examples and illustrations. Given the benefit of the above disclosure, those skilled in the art may be able to devise various modifications and alternate constructions that although differing from the examples disclosed herein nevertheless enjoy the benefits of the invention and fall within the scope of the invention, which is to be defined by the following claims.

What is claimed is:

1. In a PIR motion detector circuit for outdoor use having an amplification section for amplifying a signal from one or more infra-red sensors, a low-voltage supply level applied to power said amplification section, and a manual gain control for adjusting the signal level from said amplification section, the improvement characterized in that:
said manual gain control is disposed in said circuit such that at least a substantial fraction of said low-voltage supply level is provided across said manual gain control thereby to impede long-term failure of said motion detector circuit.

2. In a PIR motion detector circuit for outdoor use having an amplification section comprising at least a first and a last amplification stage for amplifying a signal from one or more infra-red sensors, and a manual gain control for adjusting the signal level from said amplification section, the improvement characterized in that:
said manual gain control is disposed in said circuit at said last amplification stage thereby to reduce the effect of noise introduced at said gain control and to impede long-term failure of said motion detector circuit.

3. The apparatus of claim 2 wherein said gain control is disposed after said last amplification stage.

4. The apparatus of claim 3 wherein said gain control comprises a manually adjustable resistive load at the output of said last amplification stage.

5. The apparatus of claim 2 further including a thresholding element responsive to an output signal from said last amplification stage, said thresholding element discriminating the presence or absence of desired motion in said output signal, further characterized in that
said gain control comprises a manually adjustable resistive element disposed to adjust the fraction of said output signal applied to said thresholding element.

6. The apparatus of claim 5 wherein said thresholding element comprises a window comparator.

7. In a PIR motion detector circuit for outdoor use having an amplification section comprising at least three amplification stages for amplifying a signal from one or more infra-red sensors, and a manual gain control for adjusting the signal level from said amplification section, the improvement characterized in that:
said manual gain control is disposed in said circuit between the last amplification stage and the penultimate amplification stage thereby to reduce the effect of noise introduced at said gain control and to impede long-term failure of said motion detector circuit.
